(19) United States
(12) Patent Application Publication
(10) Pub. No.: US 2025/0248339 A1
(43) Pub. Date: Aug. 7, 2025

(54) PICK-UP ATTACHMENT FOR A HARVESTING MACHINE

(71) Applicant: Carl Geringhoff GmbH & Co. Kommanditgesellschaft, Ahlen (DE)

(72) Inventors: André HEMMESMANN, Sassenberg (DE); Andreas LEUDERALBERT-BOWE, Gronau (DE); Cristiano SCHWARTZ, Ahlen (DE); Holger STRUNK, Wadersloh (DE); Reimer Uwe TIESSEN, Oldenburg (DE)

(73) Assignee: Carl Geringhoff GmbH & Co. Kommanditgesellschaft, Ahlen (DE)

(21) Appl. No.: 18/855,682

(22) PCT Filed: May 24, 2023
(86) PCT No.: PCT/DE2023/100385

§ 371 Date: Oct. 10, 2024

(30) Foreign Application Priority Data
May 25, 2022 (DE) 10 2022 113 247.1

(51) Int. Cl. A01D 89/00

(52) U.S. Cl. CPC A01D 89/008; A01D 89/002

(57) ABSTRACT

A pick-up attachment for a harvesting machine, preferably for a field chopper, includes a pick-up rotor having pick-up tools for picking crop up from the ground. The pick-up rotor is connected to at least one guide element that rests on the ground and takes on the guidance of the pick-up rotor and guides it to the ground. The pick-up attachment can be tilted toward the ground and away from the ground by an angle that can be predetermined, about an axis of rotation transverse to the direction of travel, so as to set the raking height, in such a manner that the contact point of at least one guide element shifts during tilting, and thereby the position of at least one region of the pick-up rotor and thus the distance of at least one pick-up tool situated in this region or of the raking point from the ground changes.

The invention relates to a pick-up attachment for a harvesting machine, preferably for a field chopper, in particular for a self-propelled field chopper, comprising a pick-up rotor having pick-up tools for picking crop up from the ground, wherein the pick-up rotor is connected to at least one guide element that rests on the ground, which element takes on the guidance of the pick-up rotor and guides it to the ground.

Field choppers are harvesting machines that are used for harvesting and collecting crop, cutting crop to short parallel lengths, and conveying the chopped material into containers or separate vehicles. Typical crops are grasses, straw-type crops such as alfalfa or field grass, pulses, mixtures and/or crops grown in rows, such as maize or millet. The chopped material can either be fed to the livestock directly, as fodder, or stored by means of silage or drying, so as to feed it to the livestock later, as fodder. The field chopper can harvest the crop directly, by means of cutting it off over its full width or from individual or multiple rows, or by picking it up from the swath. Field choppers can be attached to a tractor, pulled by a tractor, or self-propelled.

A harvesting attachment is a device, usually removable, for picking up the crop into the field chopper. In the case of a pick-up attachment as a harvesting attachment, this is specifically a device for holding crop that has been cut previously. In this regard, the crop can be laid down in rows or swaths.

When harvesting these materials, it is tremendously important to maintain a high crop quality and thereby a high fodder quality. The cleanliness of the crop has a decisive influence on the silage process, and, when using the crop or the silage as fodder, on the health of the animals, the life expectancy of the animals, and thereby also on the milk output and the meat yield.

Furthermore, the wear of the harvesting machines processing the crop, for example the chopping blades of the field choppers, is significantly reduced if the crop can be picked up with as little contamination as possible.

A decisive factor for gentle and clean pick-up of the crop is an optimally adjusted raking height.

The raking height is understood to be the distance between the raking point and the ground, wherein the raking point lies at the location where the envelope curve of the pick-up tools, in particular of the pick-up tines or raking tines of the pick-up rotor has the least distance from the ground.

The raking height should always be set in such a manner that the crop can be picked up completely from the ground, in other words without losses, and conveyed to the harvesting machine, in particular the field chopper. In this regard, it is important that the pick-up tools, in particular the pick-up tines, do not engage into the ground or into the turf and thereby introduce contamination into the crop and thereby into the fodder.

If the raking height is set too high, the pick-up tools, in particular the pick-up tines, no longer pick the entire crop up from the ground. Crop remains lying on the field, and thereby the harvesting yield is reduced and the further growth of the crop, for example of the grass, is inhibited.

If the raking height is set too low, the pick-up tools, in particular the pick-up tines, engage into the ground, in particular into the turf.

This results in increased contamination of the crop and thereby of the fodder, damage to the ground, in particular the turf, as well as increased wear of the harvesting attachment and the harvesting machine, in particular a field chopper, going as far as breakage of the pick-up tools, in particular of the pick-up tines, of the pick-up rotor, or further damage to the pick-up attachment and/or of the harvesting machine.

Setting and maintaining the raking height is therefore a very important factor for increasing the quality of the crop and/or fodder, as well as for reducing damage to the field, to the ground or the turf, to the pick-up attachment and/or to the harvesting machine.

The raking height must therefore constantly be checked and adapted on the basis of changing conditions, for example the ground contour, the cutting height, the composition of the crop, etc.

Known pick-up attachments are guided to the ground using guide elements, specifically feeler wheels or feeler skids. Such guide elements are arranged on the outside next to the pick-up rotor, in each instance. In part, a third guide element, namely a guide wheel or a guide skid, is additionally arranged in the center, behind the pick-up rotor.

In the case of these pick-up attachments, setting of the raking height is implemented in a decentralized manner, by means of the height adjustment of the outer guide elements, in particular of the outer feeler wheels. Decentralized means that each guide element, in other words every feeler wheel, for example, is individually displaced manually, by way of a hole grid or hole pattern or clamping rails, and thereby adjusted in terms of height and fixed in place, is adjusted in terms of height by means of a threaded spindle. For this purpose, the operator of the harvesting machine must usually get out of the driver station or driver cabin, get down from the harvesting machine, and manually adjust the height of each guide element and thereby the raking height at each guide element. Furthermore, the driver or operator setting the height must pay careful attention to ensure that the settings at the guide elements, in particular the two outer feeler wheels, in particular the guide elements arranged on the left and the right next to the pick-up rotor of the pick-up attachment, are made uniformly, so that all the pick-up tools, in particular pick-up tines, have the same distance from the ground. In the case of pick-up attachments for field choppers, it is also known that the guide elements arranged on the side next to the pick-up rotor can be adjusted in height by way of hydraulic cylinders. For this purpose, each guide element has its own hydraulic cylinder. To set the same raking height, it is necessary that the hydraulic cylinders are synchronized.

In the case of pick-up attachments for belt swathers, guidance takes place by way of skids arranged below the transverse conveying element, which skids can be separately adjusted mechanically. A further known method of guidance takes place by way of feeler wheels or chassis arranged below the transverse conveyor of the pick-up attachment, which can be separately adjusted mechanically. A further known method of guidance takes place by way of wheels arranged behind the transverse conveyor of the pick-up attachment, which can be adjusted mechanically or hydraulically.

In the case of pick-up attachments for baling presses and loading wagons, guidance takes place by way of feeler wheels or feeler skids that are arranged on the side next to the pick-up attachment, wherein the basic setting of the feeler wheels or feeler skids can be adjusted separately, mechanically, in each instance.

In grass silage, in particular, the harvesting capacity is an important factor for high fodder quality. After mowing, the meadows and fields must be cleared within a short period of time, so as to be able to silage the green fodder with an optimal dry substance content, for example. For this reason, the driver of the harvesting machine is under great time pressure in the harvesting chain. There is hardly any time to check the machine settings at every change in parcel or surface, and setting them, if necessary, to the changing and actual conditions, for example the ground contour, cutting height, composition of the crop, etc., especially not if the required adjustments must be made in a decentralized manner and therefore manually outside of the driver station or driver cabin. Furthermore, particularly in connection with grass harvesting, the areas to be harvested are frequently changed because of the great impact, so that regular monitoring and adjustment of the raking height is very important for the fodder quality.

In summary, this means that the optimal setting of the raking height is an important factor for gentle and clean pick-up of the crop, and thereby has a decisive influence on the fodder quality and thereby on the milk production and meat yield as well as the well-being of the animals. Furthermore, less introduction of dirt into the crop reduces wear of and damage to parts of the pick-up attachment and the harvesting machine.

For this reason, the raking height should be checked and set at every change in parcel or surface.

The current solutions for setting the raking height on known pick-up attachments demand great attentiveness of the driver of the harvesting machine. It is a disadvantage that the driver must leave the driver cabin to set the raking height and must manually set the corresponding guide elements on both sides of the pick-up attachment. This is time-consuming. Furthermore, frequent and also time-consuming checking of the raking height is required so as to ensure that all the pick-up tools, in particular the pick-up tines, of the pick-up rotor have the same optimal distance from the ground. If necessary, after the adjustment has been made and after a certain distance of harvesting travel, another time-consuming adjustment must take place, if the pick-up result or raking result is not satisfactory. This time is often not available, since the parcels or surfaces are changed very frequently and the time pressure is very great, in particular in the case of grass silage. This unavoidably leads to the result that the raking height is not checked and set or not checked and set often enough.

Proceeding from this state of the art, the invention is based on the task of making available an improved pick-up attachment, which, in particular, overcomes the disadvantages mentioned above and, in this regard, improves setting and maintaining the raking height, in particular.

This task is accomplished, in the case of a pick-up attachment, by means of the characteristics of claim 1. Further developments and advantageous embodiments of the invention are evident from the dependent claims.

The pick-up attachment according to the invention, for a harvesting machine, preferably for a field chopper, in particular for a self-propelled field chopper, comprises a pick-up rotor having pick-up tools for picking crop up from the ground, wherein the pick-up rotor is connected to at least one guide element that rests on the ground, which element takes on the guidance of the pick-up rotor and guides it to the ground.

The pick-up attachment according to the invention, for a harvesting machine, preferably for a field chopper, in particular for a self-propelled field chopper, comprises a pick-up rotor having pick-up tools, in particular pick-up tines, which can also be referred to as raking tines, for picking crop up from the ground, wherein the pick-up rotor is connected to at least one guide element, preferably a slide plate, that rests on the ground, which element takes on the guidance of the pick-up rotor and guides it to the ground. According to the invention, the pick-up attachment can be can be tilted toward the ground and away from the ground about an axis of rotation that runs transverse to the direction of travel in order to adjust the raking height, by an angle that can be predetermined, in such a manner that the contact point of at least one guide element shifts during tilting, and as a result, the position of at least one region of the pick-up rotor and thereby the distance of at least one pick-up tool situated in this region from the ground, i.e. its raking point relative to the ground changes.

The contact point of the guide element is the point at which the guide element comes into contact with the ground.

The raking point is situated at the location where the envelope curve of the pick-up tools, in particular of the pick-up tines or raking tines of the pick-up rotor has the least distance from the ground.

The raking height is understood to be the distance between the raking point and the ground.

The pick-up attachment with pick-up rotor is operated by the harvesting machine, in particular by the field chopper, in push operation. The pick-up attachment is therefore not pulled but rather pushed by the harvesting machine, in particular by the field chopper. For the tilting, according to the invention, of the pick-up attachment and thereby the setting of the raking height, the axis of rotation is preferably arranged close to the ground. By means of the tilting, according to the invention, about the axis of rotation, of the pick-up attachment, the raking height can be changed in a simple manner, and therefore adapted to the changing or currently found conditions, for example ground contour, cutting height, composition of the crop, etc.

In this way, an optimal raking height can be set at all times, during pick-up of the crop, and thereby gentle and clean pick-up of the crops is ensured, which then has a positive effect on the fodder quality and thereby on the milk and meat yield, as well as on the well-being of the animals. It is advantageous that in addition, less dirt is introduced into the crop, and the wear of and damage to parts of the pick-up attachment and the harvesting machine are reduced.

The guide elements that take on guidance of the pick-up rotor, guide it to the ground, and have contact with the ground, are preferably guide plates or slide plates or the like.

Preferably, tilting of the pick-up attachment, in other words quasi the angle adjustment of the pick-up attachment relative to the harvesting machine, and thereby setting of the raking height, is possible centrally, in other words in one step or from one location, in particular from the driver station or the driver cabin. As compared with the state of the art, such central operability simplifies setting the desired raking height, shortens the setting time, and improves handling, so that the raking height can be set quickly, reliably, and conveniently, and adapted to the changing or actually occurring conditions, both when changing parcels and when changing surfaces, and also within a stroke. In this way, constant, high fodder quality can be guaranteed, simultaneously with gentle and clean pick-up of the crop.

It can be advantageous if an adapter frame is provided, which is connected to the machine frame of the pick-up attachment by way of the axis of rotation, on the one hand, and has at least one holding point for the harvesting machine to hold the pick-up attachment, on the other hand, wherein the machine frame of the pick-up attachment can be tilted relative to the adapter frame and thereby relative to the harvesting machine that can be connected to the adapter frame.

The adapter frame is a frame that is built onto the machine frame of the pick-up attachment. By way of this adapter frame or add-on frame, the pick-up attachment is held and supported by the harvesting machine. In this regard, the harvesting machine can also be referred to as a carrier vehicle.

It can be advantageous if the axis of rotation is oriented horizontal to the plane of the ground, in a neutral position of the pick-up attachment.

It can be advantageous if the axis of rotation is arranged at the height of the transfer base of the pick-up attachment. In this way, unintentional relative movements or changes in the transfer geometry between the pick-up attachment and the harvesting machine, in particular, are prevented.

It can be advantageous if at least one, preferably multiple actuators, arranged transverse to the direction of travel and at a distance from one another, in particular hydraulic cylinders, linear motors and/or threaded spindles, are provided above and at a distance from the axis of rotation, in other words on the side of the axis of rotation that faces away from the ground, which actuators couple the adapter frame to the machine frame of the pick-up attachment.

By means of a change in length of the actuators, tilting of the pick-up attachment about the axis of rotation, relative to the adapter frame and thereby to the harvesting machine, is achieved. The resulting change in angle works together with the guide elements of the pick-up attachment, and thereby the raking height is changed. Depending on the predetermined change in length of the actuators, different tilting angles can thereby be set, wherein the change in length of the actuators brings about a change in the raking height.

It can be advantageous if the tilting angle of the pick-up attachment or of its machine frame, which angle can be predetermined, relative to the adapter frame and thereby relative to the harvesting machine, can preferably be brought about or set and/or regulated by means of the at least one actuator, from a central location, preferably from the driver station or from the driver cabin of the harvesting machine, preferably in an automated manner.

It can be advantageous if the at least one guide element, which is preferably a guide plate or slide plate, is arranged at a distance from the pick-up rotor, viewed in the direction of travel, ahead of or preferably behind the center point or the center axis of the pick-up rotor.

The pick-up attachment is guided to the ground by way of the guide elements. The guide elements, preferably guide plates or slide plates, are therefore situated at a distance, in the direction of travel of the pick-up attachment, ahead of or preferably behind the center point of the pick-up rotor. In particular in the case of the latter variant, a lever relationship occurs between the contact point of the guide elements relative to the raking point of the pick-up tools, in particular pick-up tines or raking tines, of the pick-up rotor. The contact point of the guide elements is—as has already been described—the point at which the guide elements come into contact with the ground. The raking point is situated at the location where the envelope curve of the pick-up tools, in particular of the pick-u tines or raking tines, of the pick-up rotor has the least distance from the ground. By means of the change in angle of the machine frame of the pick-up attachment relative to the harvesting machine, as described above, which machine can also be referred to as the carrier vehicle of the pick-up attachment in the present case, the pick-up attachment rolls over the ground by way of its guide elements. On the basis of the aforementioned lever ratio, a change in height of the raking point is brought about. As a result, a change in angle of the pick-up attachment relative to the adapter frame or to the harvesting machine is produced by means of the change in length of the actuators, in interaction with the point of rotation of the pick-up attachment, which point lies underneath. This change in angle is utilized so as to obtain a change in height of the raking point from the ground, called a raking height change, by way of the lever ratio that results from the distance between the contact point of the guide elements and the raking point of the pick-up tools, in particular of the raking tines.

It can be advantageous if the at least one actuator can be changed in length or displaced electrically, hydraulically and/or mechanically, so as to set the raking height.

It can be advantageous if the at least one actuator can be controlled and/or regulated electrically and/or hydraulically, preferably centrally from the driver station or the driver cabin of the harvesting machine.

For some purposes of use, it can be advantageous if the at least one actuator can be set non-centrally, directly or indirectly, mechanically, preferably by means of a threaded spindle. Such a setting ability is cost-advantageous.

It can be advantageous if multiple guide elements, spaced apart from one another, are arranged behind the pick-up rotor and transverse to the direction of travel. In this way, it is possible to further optimize the uniform setting of the raking height of the pick-up tools, in particular the pick-up tines, transverse to the direction of travel.

It can be advantageous if the pick-up rotor is composed of multiple segments that are connected to one another in an articulated manner, at least in part, for adaptation to the contours of the ground, and is preferably flexible over the entire working width. In this way, uniform setting of the raking height of the pick-up tools, in particular the pick-up tines, can be further optimized in the case of different ground contours transverse to the direction of travel.

In that the pick-up rotor of the pick-up attachment is composed of multiple segments that are connected to one another in an articulated manner, at least in part, the result is achieved that the pick-up rotor is flexible also transverse to the direction of travel, and thereby it can better adapt to the ground contour. Thus it is possible that the pick-up rotor adapts itself, at least in part, to the contour of the dip when traveling over a dip, or, vice versa, to the contour of an elevation when traveling over an elevation. In this regard, the pick-up rotor hangs through downward at the location in question or, vice versa, arches upward at the location in question. Because of the fact that the pick-up rotor adapts to the contour of the terrain, the pick-up rotor and thereby the pick-up tools, in particular raking tines, can be guided at an optimal distance from the turf, to pick up the crop, in connection with the setting of the raking height as described above. Therefore no harvesting losses occur, since the crop material is reliably picked up even in dips of the terrain. Furthermore, the pick-up tools, in particular the pick-up tines, are prevented from aggressively combing through the turf. Since the turf is protected as a result, and since no dirt, such as sand or soil, is picked up, contamination of the crop and thereby of the fodder is prevented, and the fodder quality is increased. The flexibility of the pick-up rotor therefore guarantees high quality of the crop and thereby of the fodder, at low harvest losses. In addition, increased machine wear is prevented, both on the pick-up attachment and on the harvesting machine.

As has already been explained, it can be advantageous if multiple guide elements are provided, distributed over the working width of the pick-up attachment, which elements take on the guidance of the pick-up rotor and/or guide it to the ground. Preferably, no guide elements are provided that are arranged on the side, next to the pick-up rotor.

It can be advantageous if at least one sensor is provided, which detects a parameter that is relevant for the raking height adjustment, for example the raking accuracy or the crop contamination, and transforms it into an electrical signal that can be used for control or regulation, in particular of the actuators, according to the definition of corresponding general conditions, and thereby the raking height can be controlled or regulated in an automated and permanent manner.

It can be advantageous if the general conditions can be prioritized in different ways, so as to thereby define different control or regulation characteristics.

It can be advantageous if at least one detector, in particular at least one sensor band, is provided, which detects the raking height and transforms it into an electrical signal that can be used for control or regulation of the actuators, and thereby the raking height is automatically kept at a constantly uniform predetermined value or can be controlled or regulated to a changeable value. In this way, the raking height can be kept constant even in the case of contour changes of the ground, for example dips or crests.

It can be advantageous if the at least one detector, in particular the at least one sensor band, detects the raking height at the height of the raking point.

It can be advantageous if a preferably mechanical display is arranged on the machine frame of the pick-up attachment, which display shows the current raking height.

It can be advantageous if the current raking height can be determined or queried by way of a sensor system on the machine frame, by way of a sensor band or in the actuators, and can be displayed on a terminal in the driver station of the harvesting machine.

It can be advantageous if at least one memory element is provided, in which data regarding the raking height are stored, which data can be called up by way of rapid access, in particular a hotkey or the like, and can be accessed automatically or semi-automatically.

It can be advantageous if the data regarding the raking height relate to upper and/or lower limit values. Thus, under certain conditions, the range or the field of the rake height setting can be limited, for example so as to prevent increased entrainment of dirt into the crop and thereby into the fodder or damage to the pick-up attachment or the harvesting machine.

After all this, the following advantages of the invention exist as compared with the state of the art:
Simple setting of the raking height
Reduction of the setting time of the raking height
Increase in the setting accuracy of the raking height
Improvement of the handling for setting the raking height
Relief of stress for the driver
Higher crop and therefore fodder quality, in particular less entrainment of dirt into the crop and thereby into the fodder
Less wear of the pick-up attachment and of the harvesting machine, in particular also less danger of tine breaks
Lower harvest losses during pick-up of the crop from the ground, due to increase in the raking quality

Further characteristics of the invention are evident from the claims, the figures, and the figure description. All of the characteristics and combinations of characteristics mentioned above in the specification, as well as the characteristics and combinations of characteristics mentioned below, in the figure description, and/or only shown in the figures, can be used not only in the combination indicated, in each instance, but also in other combinations or by themselves.

The invention will now be explained in greater detail using preferred exemplary embodiments and making reference to the attached drawings. These show:

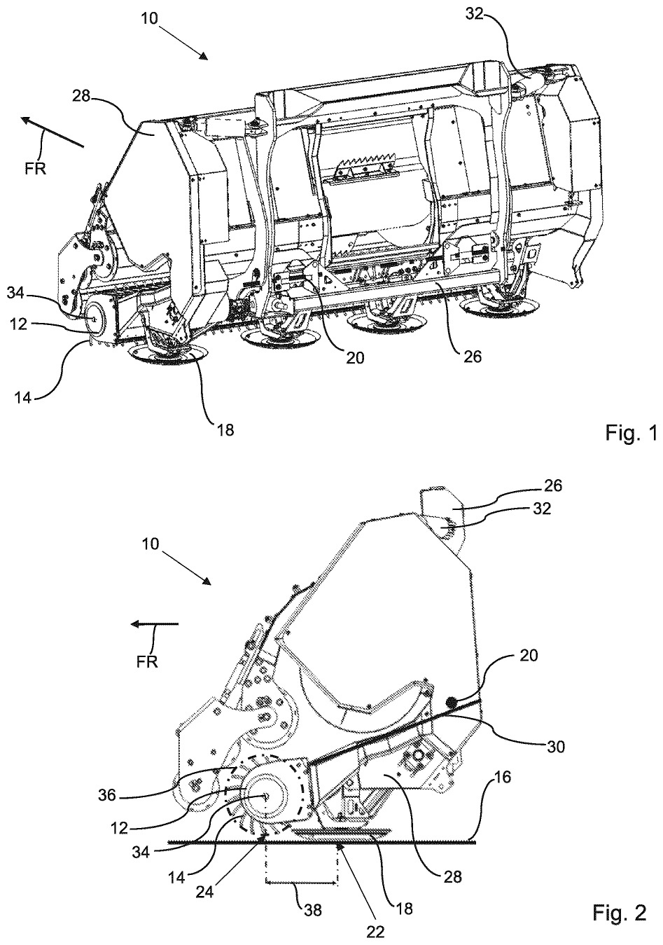

FIG. 1 a schematic perspective view of a pick-up attachment according to the invention, having an adapter frame,

FIG. 2 a schematic side view of the pick-up attachment according to the invention, according to FIG. 1,

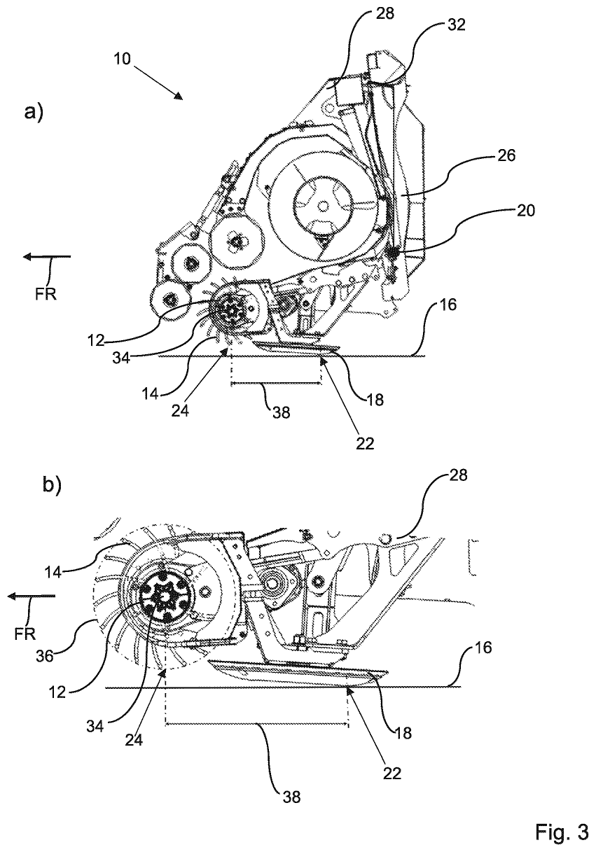

FIG. 3 a schematic side view a) of a pick-up attachment according to the invention, with a raking height set to the maximum setting, and b) a detail from FIG. 3 a),

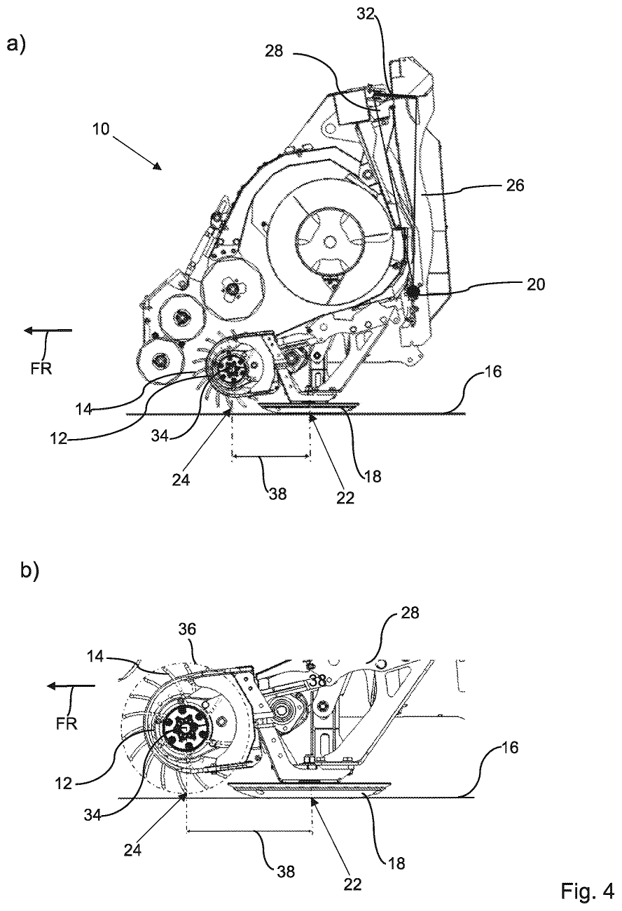

FIG. 4 a schematic side view a) of the pick-up attachment according to the invention, according to FIG. 3, with a raking height set to a center position, and b) a detail from FIG. 4 a), and

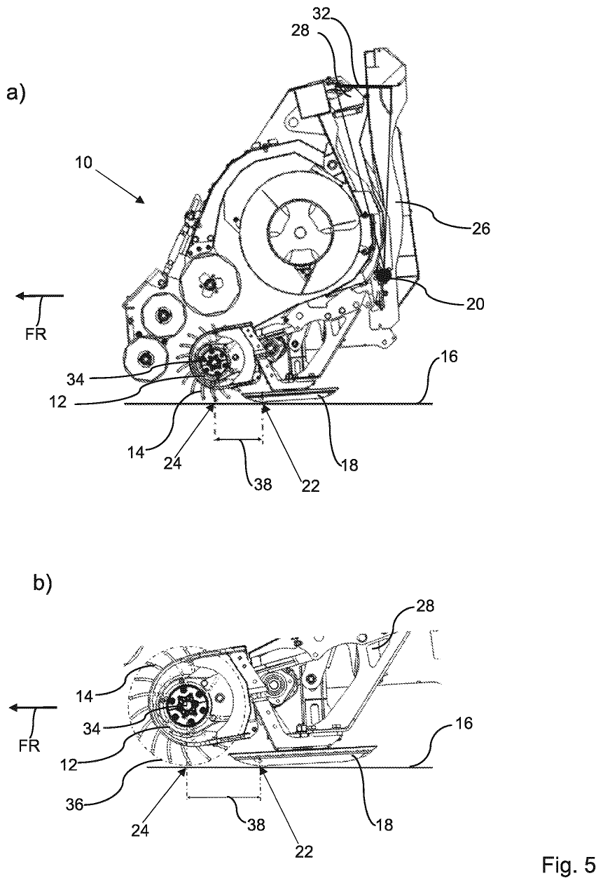

FIG. 5 a schematic side view a) of the pick-up attachment according to the invention, according to FIG. 3, with a raking height set to a center position, and b) a detail from FIG. 5 a).

If the same reference numbers are used in FIG. 1 to 5, they also refer to the same parts or regions.

FIGS. 1 and 2 show, schematically and in a perspective view and in a side view, a pick-up attachment 10 according to the invention, for a harvesting machine that is not shown here, in particular for a self-propelled field chopper. The pick-up attachment 10 comprises a pick-up rotor 12 having pick-up tools 14, which are configured as raking tines in the present case, for picking crop up from the ground 16, wherein the pick-up rotor 12 is connected to four guide elements 18 that lie on the ground 16, which elements are configured, in the present case, as slide plates. The guide elements 18 take on the guidance of the pick-up rotor 12 and guide it to the ground 16. The ground 16 usually forms the turf.

According to the invention, it is provided that the pick-up attachment 10 can be tilted toward the ground 16 and away from the ground 16 by an angle that can be predetermined, about an axis of rotation 20 that runs transverse to the direction of travel FR, so as to set the raking height, in such a manner that the contact point 22 of at least one guide element 18 shifts during tilting, and thereby the position of at least one region of the pick-up rotor 12 and thus the distance of the raking point 24 from the ground 16 changes. For this purpose, an adapter frame 26 is provided, which is connected, on the one hand, to the machine frame 28 of the pick-up attachment 10, by way of the axis of rotation 20, and, on the other hand, has at least one pick-up point for pick-up of the pick-up attachment 10 by the harvesting machine, wherein the machine frame 28 of the pick-up attachment 10 can be tilted relative to the adapter frame 26 and thereby relative to the harvesting machine that can be connected to the adapter frame 26.

In a neutral position of the pick-up attachment 10, the axis of rotation 20 is oriented horizontal to the plane of the ground 16 and at the height of the transfer base 30 of the pick-up attachment 10.

Above and at a distance from the axis of rotation 20, in other words on the side of the axis of rotation 20 that faces away from the ground 16, two actuators 32 are provided, arranged transverse to the direction of travel and at a distance from one another, which are configured as hydraulic cylinders in the present case. In FIGS. 3-5, the aforementioned actuators 32 are shown in a simplified form, for the sake of better clarity, as lines. The actuators 32 couple the adapter frame 26 to the machine frame 28 of the pick-up attachment 10.

The tilt angle of the pick-up attachment 10 and of its machine frame 28 relative to the adapter frame 26 and thereby relative to the harvesting machine can be set by means of the actuators 32. For this purpose, each actuator 32 is changeable in length, in the present case hydraulically. This is done from a central location, preferably from the driver station of the harvesting machine, wherein the actuators 32 are turned on and controlled or regulated electrically and/or hydraulically.

The four guide elements 18 are arranged at a distance from the pick-up rotor 12, behind the center point 34 or the center axis of the pick-up rotor 12, seen in the direction of travel FR. As a result, a lever ratio is formed between the contact point 22 of the guide elements 18 relative to the raking point 24 of the pick-up tools 14 of the pick-up rotor 12.

The contact point 22 of the guide elements 18 is the point at which the guide elements 18 come into contact with the ground 16. The raking point 24 lies at the location where the envelope curve 36 of the pick-up tools 14 of the pick-up rotor 12 has the least distance from the ground 16.

By means of the change in angle of the pick-up attachment 10 or the machine frame 28 of the pick-up attachment 10 relative to the adapter frame 26 and thereby relative to the harvesting machine, not shown here, the pick-up attachment 10 rolls down to the ground 16 by way of its guide elements 18. On the basis of the aforementioned lever ratio, a change in height of the raking point 24 is brought about. As a result, a change in angle of the pick-up attachment 10 relative to the adapter frame 26 or relative to the harvesting machine is produced by means of the increasing change in length of the actuators 32 shown in FIG. 3 a), 4 a) to 5 a), in interaction with the point of rotation 20 of the machine frame 28 of the pick-up attachment 10, which point lies below them. The increasing change in angle shown in FIG. 3 a), 4 a) to 5 a) is used to obtain a change in height of the raking point 24 of the pick-up tools 14 relative to the ground 16, called the raking height change, by way of the lever ratio, which results from the distance 38 between the contact point 22 of the guide elements 18 and the raking point 24 from the ground 16, called the raking height change. FIGS. 3 b), 4 b) and 5 b) show the distance that occurs between the contact point 22 of the guide elements 18 and the raking point 24 of the pick-up tools 14 and the related change in height of the raking point 24 from the ground 16, in greater detail.

### REFERENCE SYMBOL LIST

10 pick-up attachment
12 pick-up rotor
14 pick-up tool
16 ground
18 guide element
20 axis of rotation
22 contact point
24 raking point
26 adapter frame
28 machine frame
30 transfer base
32 actuator
34 center point
36 envelope curve
38 distance
FR direction of travel

1: A pick-up attachment (10) for a harvesting machine, preferably for a field chopper, comprising a pick-up rotor (12) having pick-up tools (14) for picking crop up from the ground (16), wherein the pick-up rotor (12) is connected to at least one guide element (18) that rests on the ground (16), which element takes on the guidance of the pick-up rotor (12) and guides the pick-up rotor (12) to the ground (16), wherein the pick-up attachment (10) can be tilted toward the ground (16) and away from the ground (16) by an angle that can be predetermined, about an axis of rotation (20) that runs transverse to the direction of travel (FR), so as to set the raking height, in such a manner that the contact point (22) of at least one guide element (18) shifts during tilting, and thereby the position of at least one region of the pick-up rotor (12) and thus the distance of at least one pick-up tool (14) situated in this region or of the raking point (24) from the ground (16) changes.

2: The pick-up attachment (10) according to claim 1, wherein an adapter frame (26) is provided, which is connected, on the one hand, to a machine frame (28) of the pick-up attachment (10), by way of the axis of rotation (20), and, on the other hand, has at least pick-up point for pick-up of the pick-up attachment (10) by the harvesting machine, wherein the machine frame (28) of the pick-up attachment (10) can be tilted relative to the adapter frame (26) and thereby relative to the harvesting machine that can be connected to the adapter frame (26).

3: The pick-up attachment (10) according to claim 1, wherein the axis of rotation (20) is oriented horizontal to the plane of the ground (16), in a neutral position of the pick-up attachment (10).

4: The pick-up attachment (10) according to claim 1, wherein the axis of rotation (20) is arranged at the height of the transfer base (30) of the pick-up attachment (10).

5: The pick-up attachment (10) according to claim 1, wherein at least one, preferably multiple actuators (32), arranged transverse to the direction of travel and at a distance from one another, in particular hydraulic cylinders, linear motors and/or threaded spindles, are provided above and at a distance from the axis of rotation (20), in other words on the side of the axis of rotation (20) that faces away from the ground (16), which actuators couple the adapter frame (26) to a machine frame (28) of the pick-up attachment (10).

6: The pick-up attachment (10) according to claim 1, wherein the tilt angle of the pick-up attachment (10) and of a machine frame (28) of the pick-up attachment (10) relative to the adapter frame (26) and thereby relative to the harvesting machine, which angle can be predetermined, can preferably be set by means of the at least one actuator (32), from a central location, preferably from the driver station of the harvesting machine.

7: The pick-up attachment (10) according to claim 1, wherein at least one guide element (18) is arranged at a distance from the pick-up rotor (12), viewed in the direction of travel (FR), ahead of or preferably behind the center point (34) or the center axis of the pick-up rotor (12).

8: The pick-up attachment (10) according to claim 1, wherein the at least one actuator (32) can be changed in length electrically, hydraulically and/or mechanically.

9: The pick-up attachment (10) according to claim 1, wherein the at least one actuator (32) can be controlled and/or regulated electrically and/or hydraulically.

10: The pick-up attachment (10) according to claim 1, wherein the at least one actuator (32) can be set mechanically, directly or indirectly, in a decentralized manner, preferably by way of a threaded spindle.

11: The pick-up attachment (10) according to claim 1, wherein multiple guide elements (18), spaced apart from one another, are arranged behind the pick-up rotor (12) and transverse to the direction of travel (FR).

12: The pick-up attachment (10) according to claim 1, wherein the pick-up rotor (12) is composed of multiple segments that are connected to one another in an articulated manner, at least in part, for adaptation to the contours of the ground (16), and is preferably flexible over the entire working width.

13: The pick-up attachment (10) according to claim 1, wherein at least one sensor is provided, which detects a parameter that is relevant for the raking height adjustment, for example the raking accuracy or the crop contamination, and transforms the parameter into an electrical signal that can be used for control or regulation, in particular of the actuators (32), according to the definition of corresponding general conditions, and thereby the raking height can be controlled or regulated in an automated and permanent manner.

14: The pick-up attachment (10) according to claim 1, wherein the general conditions can be prioritized in different ways, so as to thereby define different control or regulation characteristics.

15: The pick-up attachment (10) according to claim 1, wherein at least one detector, in particular at least one sensor band, is provided, which detects the raking height and transforms the raking height into an electrical signal that can be used for control or regulation of the actuators (32), and thereby the raking height is automatically kept at a constantly uniform predetermined value or can be controlled or regulated to a changeable value.

16: The pick-up attachment (10) according to claim 1, wherein the at least one detector, in particular the at least one sensor band, detects the raking height at the height of the raking point.

17: The pick-up attachment (10) according to claim 1, wherein a preferably mechanical display is arranged on a machine frame (28) of the pick-up attachment (10), which display shows the current raking height.

18: The pick-up attachment (10) according to claim 1, wherein the current raking height can be determined or queried by way of a sensor system on a machine frame (28) of the pick-up attachment (10), by way of a sensor band or in the actuators (32), and can be displayed on a terminal in the driver station of the harvesting machine.

19: The pick-up attachment (10) according to claim 1, wherein at least one memory element is provided, in which data regarding the raking height are stored, which data can be called up by way of rapid access, in particular a hotkey or the like, and can be accessed automatically or semi-automatically.

20: The pick-up attachment (10) according to claim 1, wherein data regarding the raking height relate to upper and/or lower limit values.
